(19) United States
(12) Patent Application Publication
(10) Pub. No.: US 2015/0084750 A1
(43) Pub. Date: Mar. 26, 2015

(54) Appliance Control Using Destination Information

(71) Applicant: The Chamberlain Group, Inc., Elmhurst, IL (US)

(72) Inventor: James J. Fitzgibbon, Batavia, IL (US)

(73) Assignee: The Chamberlain Group, Inc., Elmhurst, IL (US)

(21) Appl. No.: 14/036,762

(22) Filed: Sep. 25, 2013

(51) Int. Cl. G08C 19/16

(52) U.S. Cl. CPC G08C 19/16; G08C 2201/91
USPC 340/12.29

(57) ABSTRACT

A location determination device is configured to effect the transmission of a message or command to change the configuration of at least one appliance at or proximate to a premises when the current destination for the location determination device is set to a preprogrammed location corresponding to the premises. Accordingly, unintended configuration changes in appliances are avoided with the knowledge that a user of the location determination device intends to proceed to the preprogrammed location corresponding to the premises.

### TECHNICAL FIELD

This invention relates generally to control of appliances, and more particularly to control of appliances, in part, by location determination devices.

### BACKGROUND

Location determination devices, such as Global Position Satellite (GPS) receivers as may be found in typical vehicular navigation systems, mobile phones, or other devices can provide a bevy of useful information, including the current location of the device. Presently, such devices can be used, at least in part, to trigger changes in various appliances as may be used in and around a residential, commercial, or industrial property. In one such application, a location determining device may determine that it is near a known programmed location (e.g., “home”), and in response, may effect commands to operate or change various appliances at the location (e.g., adjust lighting, adjust temperature, operate a movable barrier, etc.).

For example, a location determination device may be a navigation system of a vehicle. The navigation system is preprogrammed with the home address of the owner of the vehicle. When the navigation system senses it is close to the home address, it may effect transmission of commands that, for example, open the garage door. In such an approach, the driver of the vehicle can park the vehicle in the garage without additional action to open the garage door. Other examples may include turning lights on or off and unlocking one or more doors when the vehicle is near home.

Such an approach, however, may result in unnecessary or unwanted actions or changes. For example, if the driver of the vehicle was merely passing by the home on the way to a different location, the garage door may be automatically opened (or lights activated or doors unlocked) without any regard for whether the vehicle and its user actually are destined for the home. In such situations, other undesired operations may be realized (e.g., lights are turned on when no one is home).

Further, the usefulness of systems that utilize these approaches is truly limited in that these automatic changes can be effected only when the vehicle is within a certain short distance to the preprogrammed location (e.g., home). Otherwise, when a larger distance is used, the system will generate a vastly higher amount of “false positives” that will result in many more undesired operations. For example, a command to turn the lights on when the location determination device is 20 miles from home will result in the lights being turned on whenever the vehicle is within 20 miles, even if the vehicle is simply passing through the large area on the way to a different destination. This will result in far more frequent undesired operations and is more likely to occur when the area is larger. Accordingly, operations that require longer time to be fully realized (i.e., pre-heat the oven or adjust the home's temperature) are more difficult to implement.

### BRIEF DESCRIPTION OF THE DRAWINGS

The above needs are at least partially met through provision of the appliance control using destination information described in the following detailed description, particularly when studied in conjunction with the drawings, wherein:

FIG. 1 is a block diagram of an example location determination device in accordance with various embodiments;

FIG. 2 illustrates an example contextual setting that may utilize the location determination device of FIG. 1;

FIG. 3 comprises a flow diagram of an example method to be implemented by the location determination device of FIG. 1, or another device, in accordance with various embodiments;

FIG. 4 illustrates an example set of data as may be used by the location determination device of FIG. 1, or another device, in accordance with various embodiments;

FIG. 5 illustrates an example display output as may be output by the location determination device of FIG. 1, or another device, in accordance with various embodiments;

FIG. 6 comprises a flow diagram of an alternative method to be implemented by the location determination device of FIG. 1, or another device, in accordance with various embodiments;

FIG. 7 comprises an example schedule of changes to be implemented by the location determination device of FIG. 1, or another device, in accordance with various embodiments

FIG. 8 shows an example communication network in which the location determination device of FIG. 1 operates in accordance with various embodiments;

FIG. 9 shows another example communication network in which the location determination device of FIG. 1 operates in accordance with various embodiments; and

FIG. 10 comprises a flow diagram of an example method to be implemented by other devices in communication with the location determination device of FIG. 1 in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an improved location determination device and method using the same are provided. By one example approach, the location determination device (e.g., GPS receiver, navigation system, mobile device, etc.) receives destination information that is different than its current location and determines whether the received destination information corresponds to a preprogrammed location (for example, “home”). If so, the device transmits a message to an appliance located at or near the preprogrammed destination to effect a change in the appliance's configuration. By other approaches, the device determines whether it is within a threshold distance or threshold travel time to the preprogrammed destination prior to transmission of the message. In such an instance, the message may be a command to instruct the appliance to change or do something.

By still other approaches, the device may determine a schedule of changes to effect in one or more appliances based at least in part on a determined travel time. The device may then transmit the messages according to the determined schedule. Otherwise, the device may transmit the schedule to the appliance or an appliance control server to effect the scheduled changes.

So configured, the device is capable of deciding to initiate a change in the configuration of the appliance (e.g., open the garage door or turn on the lights) only when the device is aware that the user actually is headed to the location (e.g., their “home”). This avoids the situation that may occur in the prior art of inadvertently altering the appliance (e.g., opening the garage door) when a user passes by that location while on the way to a different destination. Whereas previous solutions were based solely on the physical location of the device, the teachings herein also utilize knowledge of a user's intention (through selecting a destination) to determine whether an appliance should be altered.

Additionally, with the knowledge of the user's intent to travel to the destination, the device is not limited solely to close proximity-based decision making as with the prior art. The device may be configured to initiate changes in various appliances from a much further distance or travel time than was previously allowed. For example, the device can initiate a procedure to bring the temperature of a home up five degrees (a process that can often take over an hour) when the device knows that it is about one hour away and that the home is the destination. Previous solutions were not able to make such changes this far in advance with a high degree of confidence as, at these further distances, the user may be headed to an entirely different location and the likelihood that the user is headed home reduces drastically. Thus, additional smart-home and smart-building features can be initiated well in advance of the user's arrival, thus improving the convenience and overall quality of life for the user. All of this can be achieved with little additional effort on part of the user, who simply inputs or selects a destination in the device (e.g., the navigation system for the vehicle or a smartphone).

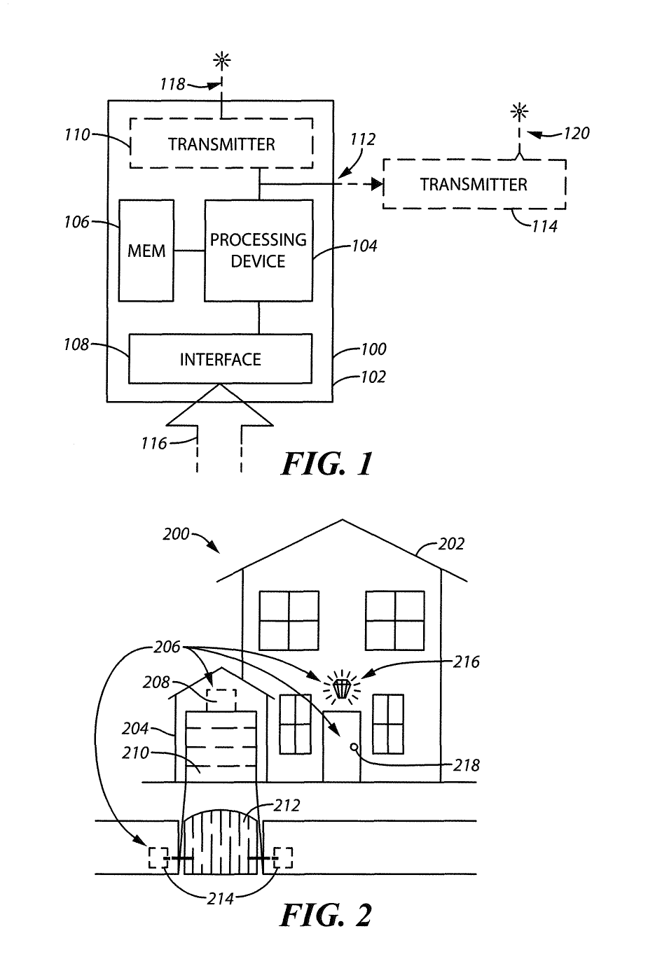

These and other benefits may become clearer upon making a thorough review and study of the following detailed description. Referring now to the drawings, and in particular to FIG. 1, an illustrative apparatus 100 that is compatible with many of these teachings will now be presented. By some embodiments, the apparatus 100 includes, at least in part, a location determination device (“LDD”) 102 such as a GPS enabled device, an automotive navigation unit, a stand-alone navigation unit, a smart phone, a tablet, a mobile communication device or other mobile device, a radar enabled device, a mobile tower triangulation enabled device, an inertial guidance enabled device, or other device capable of determining a location using presently known or unknown technology. Those skilled in the art will recognize and understand that such an LDD 102 may be comprised of a plurality of physically distinct elements as is suggested by the illustration shown in FIG. 1. It is also possible, however, to view this illustration as comprising a logical view, in which case one or more of these elements can be enabled and realized via a shared platform. It will also be understood that such a shared platform may comprise a wholly or at least partially programmable platform as are known in the art.

The LDD 102 may include one or more processing devices 104, one or more electronic storage devices 106, one or more interfaces 108, and, by some approaches, one or more transmitters 110 or other output 112 (which may, for example, communicate with an external transmitter 114). The processing device 104 is communicatively coupled to the interface, the memory, and the optional transmitter and/or other output.

The processing device 104 may comprise a processor, microprocessor, PIC processor, ARM processor, programmable logic device (PLD), logic array, digital signal processor (DSP), multi/single-core processor, or other known processing devices. Those skilled in the art will recognize and appreciate that such processing devices 104 can comprise a fixed-purpose hard-wired platform or can comprise a partially or wholly programmable platform. All of these architectural options are well known and understood in the art and require no further description here.

The processing device 104 is coupled to one or more electronic storage devices 106 such as a memory, volatile memory, non-volatile memory flash memory, RAM, ROM, DRAM, SRAM, Z-RAM, TTRM, A-RAM, ETA RAM, FeRAM, CBRAM, PRAM, SONOS, RRAM, Racetrack Memory, NRAM, Millipede Ram, a hard drive, a floppy disk, a CDR, a DVD, a Blu Ray, or any other electronic device capable of digitally storing data. By some approaches, the electronic storage device 106 may be part of the processing device 106 such as the case with on-chip memory, which may or may not be implemented with additional memory 106 external to the processing device 104.

The interface 108 is configured to receive inputs 116 used to control or otherwise utilize the LDD 102. The interface 108 may be a human interface device (HID) such as one or more keypads, buttons, knobs, levers, trackballs, mice, touch screen, voice recognition module, visual input receiver (such as a camera configured to recognize physical movements or other physical aspects), or other known input HIDs. By another approach, the interface 108 is a communication input (wired or wireless) that is configured to receive communications from other devices or modules (remote or local) that are configured to control or interact with the LDD 102. For example, the LDD 102 may be a vehicular navigation unit that is configured to receive an indication or selection of a destination from a separate mobile device (such as a smartphone or tablet). This may be useful in an instance that the user wishes to program the navigation system of their vehicle prior to entering the vehicle.

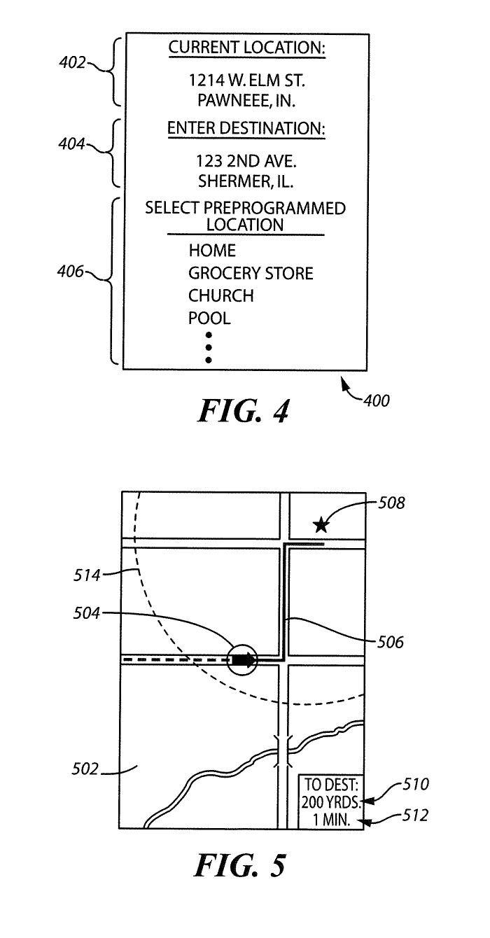

By one approach, the inputs 116 received by the interface 108 include destination information for the LDD 102 (see FIG. 4). This may include the interface's 108 receiving one or more addresses, sets of coordinates (e.g., latitude and longitudinal coordinates), graphical selections of destinations on a map, or a selection of one or more preprogrammed or suggested locations (e.g., “home,” “grocery store,” etc.). For example, a user may manipulate an HID to enter the address on a keypad or touch screen into a vehicular navigation unit or smart phone or by choosing a preprogrammed or suggested location to select as the destination, though other methods of entering or selecting a destination are contemplated by this disclosure.

By another approach, an LDD 102 may have received destination information at one time (e.g., from a user entering in an address), but later that destination may be scheduled to be selected or activated, possibly automatically, at a certain point later in time. For example, a navigation unit for a vehicle may be configured to automatically select a preprogrammed destination “home” when the vehicle is located at a known address (such as “work”) and/or it is after a certain time (such as after 3:00 pm). Along this same line, a user may preprogram a certain destination to become a current destination for a vehicle at a certain point in time, being a single point in time or a repeated point in time. For example, if a user knows they will be taking a trip on an upcoming weekend to a vacation location, they would be able to preprogram the LDD 102 on, for example, Tuesday, to automatically select the preprogrammed location at, before, or around an anticipated departure date/time of, for example, Saturday morning at 9:00 AM. Although these alternate approaches involve the LDD 102 receiving the destination information at a time that is removed from the actual activation of the destination to be the current destination for the LDD 102, these alternate approaches are within the scope of the disclosure.

In at least one approach, the LDD 102 includes a transmitter 110, which may be coupled to an antenna 118. For example, if the LDD 102 is a smartphone, it will most likely include a transmitter 110 and antenna 118 by which to communicate with cellular towers or other local area networks (LAN) such as a WiFi network. By another approach, the LDD 102 may include one or more outputs 112 configured to communicate with an external transmitter 114, which may include an antenna 120 as well. Such a system may include, for example, a vehicular navigation unit that communicates with an external garage door opener remote (such as a HomeLink®) that may be included in the vehicle but not specifically as part of the LDD 102. Another example may be a smartphone that is connected via a bluetooth interface to a vehicle to allow the smartphone to interface with the garage door opener remote. In this example, although the smartphone may include its own transmitter 110, it may also utilize an external transmitter 114 (the garage door opener remote of the vehicle) to transmit signals in a native signal format for an appliance when appropriate (e.g., to send commands directly to a movable barrier operator, such as a garage door operator or gate operator).

Although not explicitly described here, the LDD 102 may include other common structures, configurations, and functions that are known in the art, all of which are fully contemplated by this disclosure. The current teachings are compatible with all LDDs that do not prevent or inherently disallow having destination information entered or selected and effecting transmission of messages.

Referring now to FIG. 2, an example premises 200 of the preprogrammed location “home” is illustrated. In this contextual example, the premises 200 includes a dwelling 202 such as a house and a garage 204. The premises 200 may include one or more appliances 206 therein or proximate thereto. For example, the garage 204 may include a movable barrier operator (MBO) such as a garage door opener 208 configured to open the garage door 210. The premises 200 of the preprogrammed location may include other movable barriers and MBOs such as, for example, a front gate 212 and one or more gate operators 214. As shown, the premises 200 may include other appliances 206 including lights 216 or door locks 218, which may be controllable. Other examples of appliances 206 may include, though are no way limited to, a smart home controller, a climate system, a thermostat, a heating system, a cooling system, a security system, a telephone system, a television, a music device, an entertainment device, a media device, a lighting device, a microwave, a stove, a beverage center, a kitchen appliance, a hot tub controller, a sauna controller, a steam room controller, a pool controller, a window covering, a door lock, a proximity announcement device, an irrigation system, a mobile device, a beverage dispenser, and a pet management system. The list of appliances 206 that can be at or proximate to the preprogrammed location 200 is almost limitless as essentially, any appliance 206 that can communicate can be configured to be controlled, at least in part, by the LDD 102.

An appliance 206 can be considered to be proximate to the premises 200 of the preprogrammed location if, for example, it is within or near the physical real estate boundary of the premises 200 of the preprogrammed location, for example, within 100; 1,000; or 10,000 feet thereof. Alternatively, it may be further from the premises 200, but can still be considered proximate if it impacts operations occurring at the premises 200 of the preprogrammed location. For example, in a sprawling agricultural or commercial setting, a power switch that controls the incoming power for a premises 200 of the preprogrammed location may be miles away, but can still be considered proximate as its actions directly affect the operations at the premises 200.

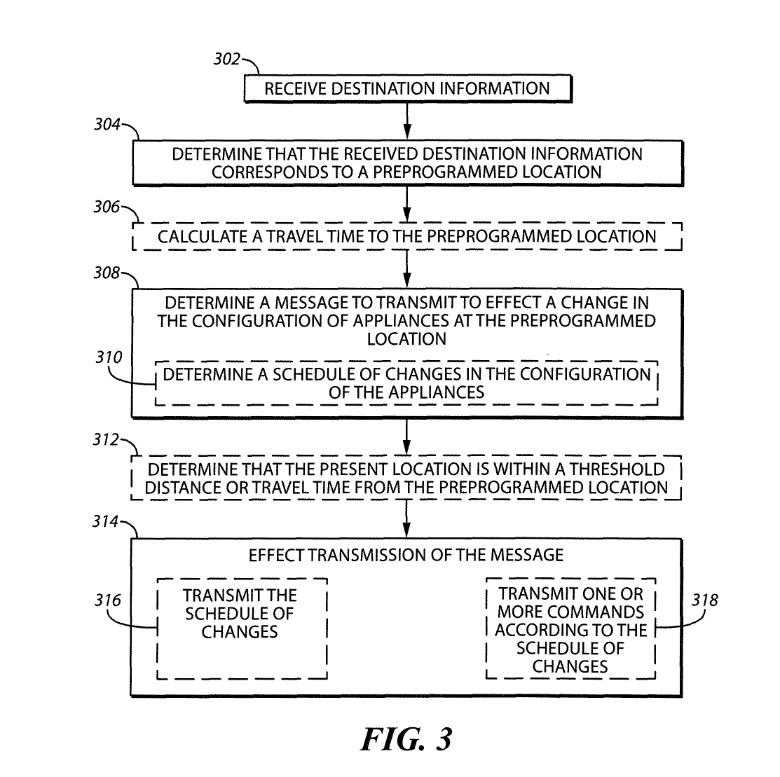

Referring now to FIG. 3, an example method 300 of operation of the LDD 102 is illustrated in accordance with various approaches. As described above, the LDD 102 receives 302 destination information via the interface 108. The receipt 302 of the destination information may include setting or activating the current destination for the LDD 102 to be the location corresponding to the received destination information. Alternatively, the setting or activation of the current destination may be performed during a different step, possibly at a different time. By one approach, the received destination information corresponds to a location that is different from the present physical location of the LDD 102. For example, the LDD 102 may receive an address or selection of a location corresponding to “home” while the user and the LDD 102 are presently located at “work.”

After receipt 302 of the destination information (and/or activation of that destination as the current destination for the LDD 102), the LDD 102 can determine 304 whether the received destination information corresponds to a preprogrammed location stored in the memory 106 at an earlier time (e.g., “home”). It should be noted that in some instances the selection of a preprogrammed location as the current destination (e.g., by selecting “home”) may serve as both the function of the LDD receiving 302 the destination information as well as the LDD 102 making the determination 304 that the received destination information corresponds to a preprogrammed location (for example, if the destination was selected from a list of preprogrammed locations). The preprogrammed location may have been entered or selected at any time prior via any method by which a user can enter destination information into the LDD 102. The LDD 102 can then store the previously entered destination information as a preprogrammed location, which storage and indication as such can occur automatically by simply entering it (e.g., as a “previous destination”), or it can be actively selected or designated as a preprogrammed location by a user (e.g., selected as a favorite or common destination, possibly including a naming designator such as “home” or “work”) or by the LDD 102 itself. For example, the LDD 102 may determine that a received destination is a location which is visited often or regularly, in which case the LDD 102 may designate it as a preprogrammed location.

In response to determining 304 that the received destination information does correspond to a preprogrammed location, the LDD 102 can determine 308 a message to transmit, which message is configured to effect a change in the configuration of one or more appliances 206 at or proximate to the preprogrammed location. The LDD 102 will then (e.g., immediately or at a later time) effect transmission 314 of the message. By one approach, the LDD 102 will wait until it determines 312 that its present location is within a threshold distance or travel time from the preprogrammed location prior to having the message transmitted 314; while by another approach the LDD 102 may have the message transmitted 314 when the message is ready and/or is capable of being transmitted. By another approach, the LDD 102 can calculate 306 an estimated travel time or travel distance until arrival at the preprogrammed location. Using this information, the LDD 102 can determine 310 a schedule of changes to effect based on threshold distances and/or travel time from the destination, or based on an actual time elapsed or distance travelled.

In one example, the message may include a command to begin effecting the change in the configuration of the appliance 206 in response to receiving the command. With such an approach, the LDD 102 can transmit 318 the message with the command at the time the configuration change should begin (e.g., at the time a garage door is to be opened or a thermostat temperature setting is to be changed). In another example, the message to begin effecting the change is transmitted according to a schedule. In another example, the message may include a schedule of changes, and the LDD 102 can effect transmission 316 of the schedule as the message. In yet another example, the message is an indication that the current destination corresponds to the preprogrammed location and/or an indication of a determined distance and/or estimated travel time to the destination and/or a current location of the LDD 102.

Various contextual examples are now described with reference to FIGS. 4 and 5. Assume the LDD 102 is a vehicular navigation unit and is presently located at a user's work. At the end of the day, the user enters and starts the vehicle and subsequently selects the preprogrammed location “home” as the current destination. This is illustrated in FIG. 4, which shows the example data 400 used by the LDD 102, some or all of which may also be output via a display in a format similar to (or different than) the illustrated example. The LDD 102 knows its current location 402 (shown here as an address, though any suitable location data may be utilized, such as coordinates, etc.). The LDD 102 also allows destination information 404 to be entered and/or selected as the current destination. For example, a user can enter the destination information 404 (e.g., the address or coordinates), or the user can select the destination from a list 406 of one or more preprogrammed locations.

FIG. 5 illustrates an example display output by an LDD 102 by one approach. Many different display types and styles may be utilized by an LDD 102, if at all, and the description provided with respect to FIG. 5 is in no way meant to be limiting. As is understood in the art, the LDD 102 can provide the user with a map 502 with an indication of a current location 504. A route 506 to a destination 508 may also be provided. The LDD 102 may also provide a distance remaining 510 until arrival at the destination and/or a remaining travel time 512 until arrival at the destination.

With the knowledge that the user intends the preprogrammed location as her actual destination, the LDD 102 will determine that it needs to initiate a change in one or more appliances 206 at some point during the travel to the destination. Returning to the example setting of FIG. 2, the LDD 102, for example, determines that it needs to have the gate 212 to begin to be opened by the gate operators 214 when the vehicle is within a threshold of 300 yards or 90 seconds from the destination 200 and needs to have the garage door 210 to begin to be opened by the garage door opener 208 when the vehicle is within a threshold of 100 yards or 45 seconds from the destination. As illustrated in FIG. 5, the LDD 102 can display its current location 504 optionally in the center of the display and optionally as an arrow (conveying both location and heading) traveling along a route 506 to the destination 508. A remaining travel distance 510 is shown in this example as 200 yards and an estimated remaining travel time 512 is shown as 1 minute. The remaining distance 510 is within the threshold of 300 yards (and the remaining travel time 512 is within the threshold of 90 seconds), and thus the LDD 102 will (or already has) caused the command to begin opening the gate 212 to be transmitted. However, because the LDD 102 has not traveled to within 100 yards or 45 seconds from the destination, it has not yet caused the command to begin opening the garage door 210 to be transmitted. In one approach, the LDD 102 can make these determinations as to when to send the messages by virtue of creating a schedule based on this criterion, or, alternatively, waiting until the LDD 102 is within the preset thresholds to transmit the messages. Accordingly, as the driver approaches the destination, the gate 212 and garage door 210 will open just prior to arrival so as to provide the convenience and luxury of these actions being performed automatically, while retaining as much security as possible by only opening then with the knowledge that the premises 200 is the actual destination.

Further, by only sending the messages when the LDD 102 knows the user intends to actually proceed to that specific destination (by virtue of the destination information corresponding to the preprogrammed location), the LDD 102 avoids enacting the changes unnecessarily, which can result in unwanted actions (for example, in the instance of opened barriers, unlocked doors, or disabled alarm systems) or wasted activity or energy (for example, in the instance of changed thermostat temperatures or activation of lights). Thus, rather than relying exclusively on the fact that the LDD 102 is within a threshold distance or travel time to determine whether to transmit a message, the LDD 102 can determine whether to transmit the command also based on if the user intends to actually proceed to that destination. This is useful in situations where a user may be traveling past the location or within a set threshold distance of the location, but not actually proceeding to the location (e.g., simply driving by their home on the way to the grocery store). In such an instance, it would be beneficial to withhold sending the message to open the gate or garage door when the defined destination is either null or defined as a different location.

In an alternate approach, the LDD 102 may make current distance and distance threshold determinations based on a radius distance from the destination, as is shown by the radius 514 (which may or may not appear on a graphical map). Here, the radius 514 may pertain to the example 300 yard threshold corresponding to opening the gate. Instead of a remaining travel distance, the LDD 102 may use a radius-based current distance calculation to determine that it is within the radial threshold 514 to initiate transmission of the command. This approach may not necessarily be as useful in instances where a route may take the user inside and then outside of the radial threshold (for example, with on winding streets or while going around an obstacle such as a body of water or a park) and could still result in prematurely performing an action (such as opening the garage door when the vehicle is within 300 yards, but still may have a mile or more to travel to go around a lake). Such an approach, however, is useful in that it may require less calculation to determine the distance (i.e., a straight vector calculation of a distance rather than accounting for the actual travel distance on streets). Further, such an approach relies less on a suggested route of travel created by the LDD 102 or another device, which are not always adhered to by a user. Further still, the differences between a radial distance 514 and a remaining travel distance 510 often become comparatively miniscule as the values increase as the user of the LDD 102 will typically travel in a direction generally towards the destination. Thus, in instances where the threshold is, for example, 100 miles, and the operation is, for example, to begin increasing the temperature of the house by 5 degrees, whether such a determination is based on remaining travel distance 510 or radial distance 514 becomes less important as the difference may be small and the precision of the operation is less crucial or controllable (e.g., it may take anywhere between 30 and 120 minutes to change the temperature of the house, and the exact temperature presents relatively no security risk).

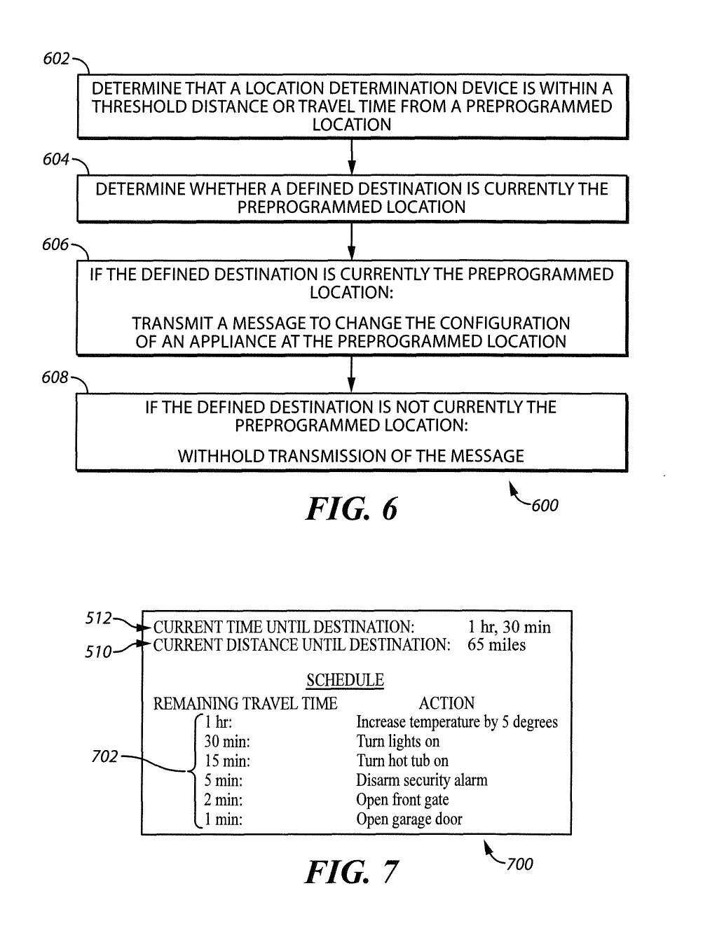

Referring next to FIG. 6, an alternate method 600 used in conjunction with the LDD 102 (or another device) is provided. In a similar fashion as discussed above, an LDD 102 determines 602 that the LDD 102 is within a threshold distance or travel time from a preprogrammed location (for example, the threshold distance 510 or travel time 512 to “home” as illustrated in FIG. 5). The LDD 102 can determine 604 if a defined destination for the LDD (i.e., the currently set destination) is set to the preprogrammed location (e.g., “home”). If the defined destination is currently set to the preprogrammed location, then the LDD 102 can then effect transmission 606 of a message, which message can effect a change in the configuration of at least one appliance 206 at or proximate to the preprogrammed location (e.g., open the garage door at “home”). However, if the LDD 102 determines that the defined destination is set to null (e.g., not set at all) or set to a location other than the preprogrammed location (e.g., “work”), then the LDD 102 will withhold 608 transmission of the message in response to making such a determination.

By other approaches, the LDD 102 may prompt or query a user if they wish to effect transmission of the message independent of or despite the defined destination not being set to the preprogrammed location. For example, the LDD 102 may cause to be displayed or announced “You are close to preprogrammed location “home”—would you like to open the garage door?” By other approaches, the LDD 102 may prompt the user even if the defined destination is set to the preprogrammed location to simply ensure the user indeed wishes for the certain task to be performed. The LDD 102 may then receive feedback from the prompt in the form of a response (e.g., yes/no) or a lack of a response (e.g., letting a response timer expire without a response to the prompt). The prompt may be in the positive (e.g., “would you like to open the garage door?”), which would require a response for the task to be performed. Alternatively, the prompt may be in the negative (e.g., “would you like to withhold or postpone opening the garage door?”), in which case a response will prevent performance of the task, but a lack or response (for example, within a time limit of 10, 20, or 30 seconds or other appropriate times) may still result in the task being performed. If the LDD 102 receives feedback (e.g., an actual response, or lack thereof) from the prompt indicative of a selection to effect the at least one change in the configuration of the appliance, then the LDD 102 may effect transmission of a message to effect the change in the configuration of the appliance.

It should be noted that by yet another approach, all the actions and determinations described above with reference to FIG. 6 (as well as FIG. 3) as being performed by the LDD 102 may be performed by another device such as a server 914 or controller 812, which are discussed in more detail below.

Referring next to FIG. 7, an example schedule 700 of changes to effect in at least one appliance 206 at or proximate to the premises of the preprogrammed location is illustrated. This schedule 700 may exist internal to the LDD 102 (e.g., in the memory 106) or in some other device, or alternatively, may be displayed as shown (or in a different format) by the LDD 102 or by another device (such as another computing device that can communicate with and/or control the LDD 102). By one approach, a schedule 700 is created by first calculating or estimating a remaining distance 510 or a remaining travel time 512 until arrival at the destination. The schedule 700 may then be created based on a list of events 702 that should be performed according to various aspects of the travel progression. For example, and as is shown here, a schedule 700 is created that links certain actions to specific amounts of remaining travel time, such as may be determined using available traffic condition data, road construction data, weather data, and the like. Here, the schedule indicates that when there is one hour remaining in travel time, an action should be initiated such that the temperature of a building or dwelling at the destination premises begins to increase the temperature by 5 degrees. At 30 minutes remaining, an action should be initiated to turn various lights on at the destination location. At 15 minutes remaining, an action should be initiated to turn on a hot tub at the destination location. At 5 minutes remaining, an action should be initiated to disarm a security alarm at the destination location. At 2 minutes remaining, an action should be initiated to open a front gate at the destination location. At 1 minute remaining, an action should be initiated to open a garage door at the destination location. As mentioned above, the schedule 700 could be based on a remaining distance 510 to travel instead.

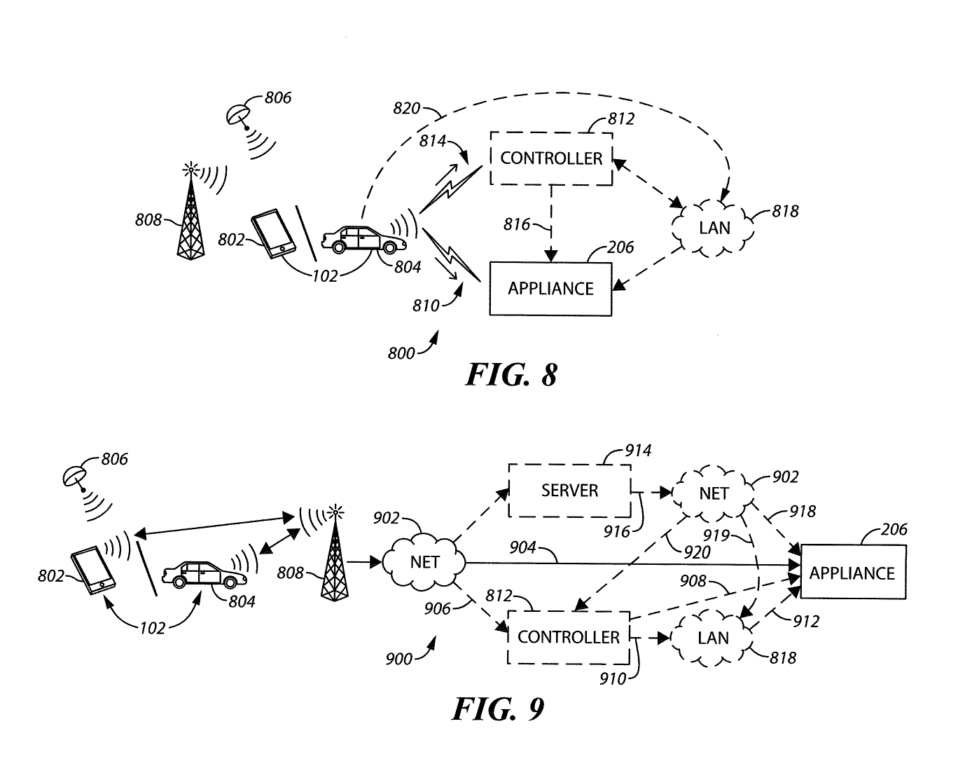

Further, by other approaches, the schedule 700 may be created based on time that has elapsed since its creation, from the beginning of the trip, or from some other point in time. So, in the example schedule 700 of FIG. 7, which provides an example current remaining time 512 of 1 hour and 30 minutes, the list of events 702 might read as follows: at 30 minutes into the trip, initiate an action to increase the temperature of the building; at 1 hour into the trip, initiate an action to turn the lights on; and so forth. Alternatively still, in a similar manner, the schedule 700 could be based on distance traveled. Further, the schedule 700 is not necessarily limited to being created, managed, or implemented by the LDD 102. As is discussed below, other devices can create, manage, or implement the schedule 700 based on information that is received from the LDD 102 (e.g., that a current destination corresponds to a preprogrammed location, current location information, target destination information, calculated travel time or distance, etc.). These other devices may include a central server 914 or a local or remote controller 812 (see FIGS. 8 and 9).

This schedule 700 can be created well in advance by a user or by a program configured to suggest or create schedules so that these actions are implemented simply by a user indicating to the LDD 102 that the current destination is the applicable location. As noted above, this indication can be expressly indicated (for example, by actively entering or selecting the preprogrammed location) or can be passively indicated (for example, if the LDD 102 suggests and/or automatically implements a route based on current date/time and/or current location, which the user can possibly accept or override). Thus, the convenient and luxurious feature of having these actions automatically and timely performed is initiated simply by having the destination set to the preprogrammed location (i.e., “home”).

Referring next to FIG. 8, an example communication network 800 in which the LDD 102 operates is illustrated in accordance with various embodiments. The LDD 102 (shown here as either a smart phone 802 or a vehicular navigation system 804) receives signals from one or more GPS satellites 806 to make a determination of its current location. Alternatively, the LDD 102 may receive signals from local cellular towers 808 and use cellular triangulation to make a determination of current location. Other methods of position determination are possible, including radar, inertial position detection, dead reckoning, or other known methods, though GPS is preferred for its accuracy and widespread implementation. In a basic situation, the LDD 102 will effect transmitting messages and/or commands to the appliance 206 at or proximate to the premises of the preprogrammed location through a wireless connection 810 directly to the appliance 206, preferably in the appliance's native wireless protocol. For example, if the LDD 102 is a vehicular navigation unit, the LDD 102 can send a command directly to a garage door opener through a HomeLink® module in the vehicle using the garage door opener's native radio frequency (RF) protocol.

By another approach, the premises of the preprogrammed location (or a location proximate thereto) may include a controller 812 or processing device configured to control various automated aspects as discussed herein. The controller 812 may be a stand alone dedicated controller or may be incorporated into a different module such as a home or business automation unit, a security unit, and the like. The LDD 102 may effect transmitting the messages to the controller 812 instead of directly to the appliance 206 using wireless communications 814. By this alternate approach, an LDD 102 need only be programmed to communicate with the controller 812, which reduces the knowledge required by the LDD 102 of various communication protocols and native communication schemes required to communicate with a plurality of different appliances 206. Instead, the LDD 102 simply communicates with the controller 812, which controller 812 in turn handles the communications with the appliances 206. This may provide ease of implementation as, like the controller 812, many of the appliances 206 are at or proximate to the premises of the preprogrammed location.

Continuing with FIG. 8, the controller 812 can communicate with the appliance 206 through a direct connection 816 or through a local area network (LAN) 818 (which connections can be wired or wireless) to effect the changes in the appliance 206. In an alternate approach, the LDD 102 may effect transmitting messages to the appliance 206 or to the controller 812 through a LAN 818. For example, the LDD 102 may include or be connected 820 to a WiFi transceiver that can then transmit commands via WiFi through the LAN 818 to the controller 812 and/or the appliance 206.

With reference to FIG. 9, a more advanced communication scheme 900 is illustrated in accordance with various approaches. Whereas the scheme of FIG. 8 may be limited to a relatively close proximity to the premises to effect transmissions 810, 814 from the LDD 102 to the appliance 206 or controller, the scheme of FIG. 9 provides a solution that is capable of accommodating communications over much further distances. Like FIG. 8, the LDD 102 is again depicted as a smartphone 802 or a vehicular navigation unit 804 (though other devices are possible) and may receive signals from one or more GPS satellites 806 and/or cellular towers 808 (when using cellular tower triangulation) to determine current location. However, instead of communicating locally to the appliance 206 (or controller), the LDD 102 communicates through a wide area network (WAN) and/or the Internet (NET) 902 to send messages. For example, the LDD 102 can effectuate commands to be transmitted to cellular towers 808 (or via other wireless WAN data providers) through the Internet 902 directly to the appliance 206 (in an instance where the appliance 206 is Internet capable), as is shown by route 904. By another approach, the command can be sent via the Internet 902 to the local controller 812 located at the premises of the preprogrammed location (as is shown by route 906), which controller 812 is remote from the LDD 102. As with FIG. 8, the controller 812 can then send messages to the appliance 206 directly (via 908) or through a LAN 818 (via 910 and 912).

With continued reference to FIG. 9, in yet another approach, the commands can be sent via the Internet 902 to a central server 914 that is remote from the LDD 102 and remote from the premises of the preprogrammed location. Such a server 914 may be used to provide a service that can effect the changes in the appliances 206. The server 914 can then communicate the messages to the appliance 206 through the Internet 902 (through routes 916 and 918). As above, the LAN 818 may also be included in the communication path from the Internet 902 to the appliance 206 (via routes 919 and 912). Alternatively, the server 914 can communicate the messages through the Internet 902 to the controller 812 at the premises (through routes 916 and 920), which controller 812 can in turn communicate the messages to the appliances 206 as discussed above.

The server 914 may have a database of various protocols and communication schemes required to communicate with a plethora of different appliances 206. Maintenance of such a database can then be centralized by the service provider such that any updates required can be easily implemented rater than requiring updates for multiple controllers. For example, the release of various new or updated appliances 206 that are configured to communicate with external devices (such as a server 914, a controller 812, or even a smartphone 802) can prompt the need to update the database, which can then easily be updated due to its centralized nature. Further, a central server 914 implementation may provide an option for users to log on to web pages from personal computers or smartphones 802 to program or alter various aspects of the schedule, preprogrammed locations, and other factors that impact the automatic nature of the various changes in the appliances 206.

Because the LDD 102 is capable of operating in these various communication schemes 800, 900 as depicted in FIGS. 8 and 9, the system as a whole is capable of allowing the LDD 102 to effect changes in appliances 206 not only from a relatively proximate location, but also from relatively limitless distances. So configured, appliances 206 can begin to change configurations or operations much earlier during the travel time so that their effects may be fully implemented by time of arrival or carefully executed in a proper order. For example, unlike a movable barrier operator (like a garage door opener 208 or gate operator 214), which can be operated immediately prior to arrival, a temperature change within a dwelling or building may require additional time to be fully realized. As such, it is beneficial to initiate that change earlier with the knowledge that the user actually intends to proceed to the preprogrammed location so that by time of arrival, the change has been fully effected (or at least substantially underway). The disclosed long-distance communication schemes 900 of FIG. 9 allow for these types of operation and their corresponding benefits.

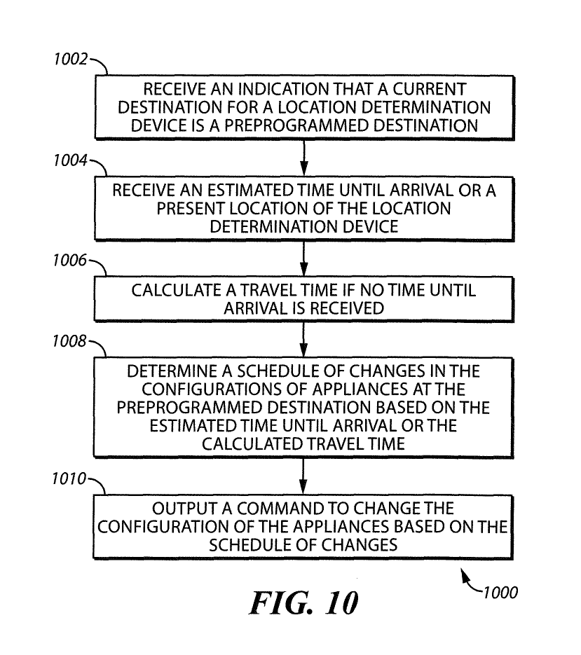

Referring next to FIG. 10, a flow chart for a method 1000 illustrating one example of this alternate approach is provided. The server 914 or controller 812, which is remote from the LDD 102, can receive 1002 from the LDD 102 an indication that the current destination set for the LDD corresponds to a preprogrammed destination. This may comprise the server 914 or controller 812 receiving, for example, a message that indicates that the user has set the current destination to a preprogrammed location, or may further comprise information corresponding to the destination (such as the address or the coordinates of the currently set destination), which the server 914 or controller 812 can then compare to a list of preprogrammed locations to determine that the received destination does correspond to a preprogrammed location. The server 914 or controller 812 may then receive 1004 from the LDD 102 an estimated time until arrival, travel distance until arrival, and/or a present location of the LDD 102. If the server 914 or controller 812 does not receive an estimated time until arrival or an estimated remaining travel distance, or if it is programmed to dually calculate these metrics, it can calculate 1006 a travel time or travel distance, respectively, based at least in part on a present location of the LDD 102. With the knowledge of either the received estimated time until arrival or the calculated travel time, the server 914 or controller 812 can determine 1008 the schedule 700 of changes based on one of these metrics. Once the schedule 700 is created, the server 914 or controller 812 can output 1010 one or more commands to change the configuration of the various appliances 206 according to the schedule 700 of changes. Thus, by this alternate approach, the LDD 102 simply communicates to the server 914 or controller 812 at the onset of the trip (or at some point during the trip) and the server 914 or controller 812 (or both) will take care of the determinations and control of the appliances 206.

In some instances, the LDD 102 can provide status updates during travel with updated current location information or time until arrival or remaining travel distance until arrival to the server 914 or controller 812 such as in the case of changing traffic conditions. Thus, the schedule 700 can be continuously adjusted according to changing parameters. Further, by another approach, the LDD 102 can provide a continuous or semi-regular update of current location of the LDD 102, and with this real-time update information, the server 914 or controller 812 can perform all of the processes described earlier with respect to the LDD 102 (i.e., in relation to FIGS. 3 and 6).

So configured, an LDD 102, or another device such as the server 914 or controller 812, can initiate changes in configurations of appliances 206 at a specific location only when it has the knowledge that the user intends to travel to that specific location through their setting of that location as the current destination for the LDD 102. Thus, with this extra knowledge of the user's intention, the change is effected only when it is proper to do so. Thus, the convenience and luxury of automation based on proximity is further refined to reduce or eliminate occurrences of inadvertent triggering when the location is not the actual intended destination. Further, by taking in account the user's intentions, changes can be initiated from a much further distance than previously allowed and according to schedules, which provide for added flexibility in implementation resulting in enhanced luxury and convenience.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Those skilled in the art will also recognize that a wide variety of modifications, alterations, and combinations can be made with respect to the above described embodiments without departing from the scope of the invention, and that such modifications, alterations, and combinations are to be viewed as being within the ambit of the inventive concept.

We claim:

1. A method comprising:
receiving at a location determination device destination information that is different from a present location of the location determination device;
determining by the location determining device that the destination information corresponds to a preprogrammed location;
determining by at least one of the location determining device or a processing device located remotely from a location determination device at least one message to transmit to effect at least one change in a configuration of at least one appliance located at or proximate to the preprogrammed location; and
effecting transmission of the at least one message.

2. The method of claim 1 further comprising:
determining by the at least one of the location determining device or the processing device that the present location of the location determining device is within one or both of a threshold distance or threshold travel time to the preprogrammed location prior to effecting transmission of the at least one message; and
wherein the at least one message comprises a command to begin effecting the change in the configuration of the at least one appliance in response to receiving the at least one message.

3. The method of claim 1 further comprising:
calculating by the at least one of the location determining device or the processing device a travel time from the present location of the location determination device to a location corresponding to the destination information; and
determining by the at least one of the location determining device or the processing device a schedule of at least one change to effect in the at least one appliance based at least in part on the travel time.

4. The method of claim 3 wherein effecting transmission of the at least one message comprises effecting transmission of the schedule to effect the at least one change in the configuration of the at least one appliance according to the schedule.

5. The method of claim 3 wherein effecting transmission of the at least one message comprises effecting transmission of a command according to the schedule to begin effecting the change in the configuration of the at least one appliance.

6. The method of claim 1 wherein the at least one appliance comprises a movable barrier operator, and wherein the at least one message to transmit to effect at least one change in the configuration of at least one appliance further comprises a message to command the movable barrier operator to open a movable barrier.

7. The method of claim 1 wherein effecting transmission of the at least one message comprises effecting transmission of a command in a native wireless communication scheme of the at least one appliance to the at least one appliance.

8. The method of claim 1 wherein effecting transmission of the at least one message comprises effecting transmission of a message through a wireless wide area network to at least one of an appliance control server, an appliance control device, and the at least one appliance.

9. A location determination device comprising:
an interface configured to receive at least one command to define a destination for the location determination device that is different from a present location of the location determination device;
a memory configured to store at least one preprogrammed location;
a wireless transmitter; and
a processing device configured to:
determine whether the defined destination corresponds to the at least one preprogrammed location;
determine at least one message to effect at least one change in a configuration of at least one appliance located at or proximate to the preprogrammed location; and
effect transmission of the at least one message via the wireless transmitter in response to determining that the defined destination corresponds to the at least one preprogrammed location.

10. The location determination device of claim 9 wherein the processing device is further configured to:
determine that the present location of the location determining device is within one or both of a predetermined threshold distance or threshold travel time to the preprogrammed location prior to effecting transmission of the at least one message;
and effecting transmission of the at least one message in response to determining the present location is within one or both of the predetermined threshold distance or threshold travel time, wherein the at least one message comprises a command to begin effecting the change in the configuration of the at least one appliance in response to receiving the at least one message.

11. The location determination device of claim 9 wherein the processing device is further configured to:
determine that the present location of the location determining device is within a one or both of a predetermined threshold distance or threshold travel time to the preprogrammed location prior to effecting transmission of the at least one message; and
withhold transmission of the at least one message in response to at least one of determining that the defined destination does not correspond to the preprogrammed location or determining that a command to define a destination for the location determination device has not been received at the interface.

12. The location determination device of claim 9 wherein the processing device is further configured to:
calculate a travel time from the present location of the location determination device to the defined destination; and
determine a schedule of at least one change to effect in the configuration of the at least one appliance based at least in part on the travel time.

13. The location determination device of claim 12 wherein the processing device is further configured to:
effect transmission of the at least one message via the wireless transmitter, wherein the at least one message comprises the schedule to effect the at least one change in the configuration of the at least one appliance according to the schedule.

14. The location determination device of claim 12 wherein the processing device is further configured to:
effect transmission of the at least one message via the wireless transmitter according to the schedule, wherein the at least one message comprises a command to begin effecting the change in the configuration of the at least one appliance.

15. The location determination device of claim 9 wherein the wireless transmitter is further configured to transmit the at least one message through a wireless wide area network to at least one of an appliance control server, an appliance control device, and the at least one appliance.

16. A method comprising:
determining by a location determination device that the location determination device is within at least one of a threshold distance or threshold travel time to a location corresponding to a preprogrammed location;
providing a prompt to determine whether to effect at least one change in a configuration of at least one appliance located at or proximate to a location corresponding to the programmed location;
receiving feedback from the prompt indicative of a selection to effect the at least one change in the configuration of the at least one appliance;
the location determination device effecting transmission of a message to effect the at least one change in the configuration of the at least one appliance in response to receiving the feedback.

17. A method comprising:
determining by a location determination device that the location determination device is within at least one of a threshold distance or threshold travel time to a location corresponding to a preprogrammed location;
determining by the location determination device whether a defined destination for the location determination device is currently defined as the preprogrammed location;
the location determination device effecting transmission of a message to effect at least one change in a configuration of at least one appliance located at or proximate to a location corresponding to the programmed location in response to determining that the defined destination is currently defined as the preprogrammed location; and
the location determination device withholding transmission of the message in response to determining that the defined destination is one or both of null or defined as a location other than the preprogrammed location.

18. A method comprising:
receiving, at a processing device located remotely from a location determination device, an indication from the location determination device that a current destination set for the location determination device corresponds to a preprogrammed destination and at least one of an estimated time until arrival at the preprogrammed destination or a present location of the location determination device;
calculating a travel time based at least partially upon the preprogrammed destination and the present location of the location determination device in response to receiving the present location of the location determination device and not receiving the estimated time until arrival;
determining by the processing device a schedule of at least one change in a configuration to effect of at least one appliance located at or proximate to the preprogrammed destination based at least in part on at least one of estimated time until arrival and the calculated travel time; and
outputting by the processing device at least one command to begin effecting the change in the configuration of the at least one appliance based at least in part on the schedule.

19. The method of claim 18 wherein the processing device is located at or proximate to the preprogrammed destination and wherein receiving the indication from the location determination device further comprises receiving the indication from the location determination device via a wide area network.

20. The method of claim 18 wherein the processing device is located remotely from the preprogrammed destination and wherein:
receiving the indication from the location determination device further comprises receiving the indication from the location determination device via a wide area network; and
outputting the at least one command further comprises outputting the at least one command via the wide area network.
